(19) United States
(12) Patent Application Publication
(10) Pub. No.: US 2019/0126336 A1
(43) Pub. Date: May 2, 2019

(54) DEVICE AND METHOD FOR FLANGING AN END OF A RIGID TUBE FOR CONVEYING FLUID

(71) Applicant: Parker-Hannifin Corporation, Cleveland, OH (US)

(72) Inventors: Philip A. Landis, Hilliard, OH (US); Le Yu, Dublin, OH (US); Burleigh G. Bailey, Hilliard, OH (US); Theodore T. Amling, Upper Arlington, OH (US)

(21) Appl. No.: 16/139,435

(22) Filed: Sep. 24, 2018

Related U.S. Application Data
(60) Provisional application No. 62/580,730, filed on Nov. 2, 2017.

(51) Int. Cl. B21D 19/12; B21K 23/04; B21K 21/12; F16L 19/028

(52) U.S. Cl. CPC B21D 19/12; F16L 19/028; B21K 21/12; B21K 23/04

(57) ABSTRACT

Provided is a die and a method for forming a flange at an axial end of a rigid metal tube. The die is configured to be engaged by a forming tool to deform the axial end of the rigid metal tube into the flange suitable for providing a leakproof link with an external sealing element. A flange recess in the die provides a shutoff-surface for defining a radially outermost perimeter of the flange formed in the flange recess, and a groove, disposed axially adjacent the flange recess, that is configured to provide for direction of overflow material of the rigid tube during flange formation. The groove aids in enabling an adequately sized planar sealing face of the flange while reducing or altogether preventing formation of flashing at the sealing face.

### FIELD OF INVENTION

The present invention relates generally to a die for use with a flanging tool to form a flange, and more particularly to a die adapted for mating with a moveable flanging tool to provide an accurately dimensioned flange at the ends of tubes of varying sizes and against a tube fitting disposable about the tubes.

### BACKGROUND

A leakproof link between rigid metal tubes, or between a metal tube and the various openings of devices in a system transferring fluid, is often carried out with a flared or flanged connection. One type of flange connection comprises a fitting disposed about a rigid metal tube, with a flange of the tube formed against an axial end of the fitting, such as by a flange forming die and forming tool. The flange may be cold formed by deforming an axial end of the rigid metal tube.

The flange generally includes a generally planar sealing face for seating against an external sealing element to provide a leakproof connection for passage of a fluid between the rigid metal tube and a passage disposed through the sealing element. The planar sealing face must be of sufficient area having a sufficient outer diameter to provide for the leakproof connection with the external sealing element, and to meet respective industrial standards.

Often in forming such a flange, difficulties arise in that dimensions of the sealing face may be inconsistent from part to part. For example, a reduced outer diameter of the sealing face may not provide an adequate land for making a leakproof seal with the external component. Alternatively, the outer diameter may be too large or generally non-circular due to the formation of flashing at the outer perimeter of the axial sealing face. The flashing may project radially outwardly from an outermost perimeter of a body of the flange, requiring additional machining steps to de-flash or de-bur the axial sealing face.

### SUMMARY OF INVENTION

The present invention provides an improved die and a method using the die for forming a flange at an axial end of a rigid metal tube. The die is configured to provide for the formation of flanges having consistent and adequate dimensions for making leakproof connections with external sealing elements. The die is likewise configured to reduce or altogether fervent formation of flashing at the respective axial sealing faces of the flanges.

Generally, the die is configured to be engaged by a forming tool to deform the axial end of the rigid metal tube into the flange suitable for providing a leakproof link with an external sealing element. A flange recess in the die provides a shutoff-surface for defining a radially outermost perimeter of the flange formed in the flange recess, and a groove, disposed axially adjacent the flange recess, that is configured to provide for direction of overflow material of the rigid tube during flange formation. The groove beneficially aids in enabling an adequately sized planar sealing face of the flange while reducing or altogether preventing formation of flashing at the sealing face.

One aspect of the invention is a die for receiving a fitting disposed about a rigid tube, the die being for use with a tool to deform an axial end of the rigid tube into contact with an axial end face of the fitting. The die includes a die body having a passage extending through the die body along a longitudinal die axis between a proximal end face and a distal end face disposed opposite the proximal end face.

The die body defines a flange recess having a radially inwardly directed forming surface configured to be engaged by material of the axial end of the rigid tube that is deformed into the flange recess. The forming surface provides a shutoff-surface for defining a radially outermost perimeter of a flange to be formed from the material of the axial end of the rigid tube. A fitting recess is disposed axially proximate to the flange recess for receiving the fitting. The fitting recess extends between the forming surface and an axially facing shelf for receiving the fitting. The fitting recess includes a proximally-located groove and a distally-located containment surface. The containment surface is disposed axially adjacent the axially facing shelf and is a radially inwardly directed surface of constant diameter over an axial length of the containment surface for supporting a radially outermost extent of the fitting. The groove is axially disposed between the forming surface and the containment surface to provide for direction of overflow material of the rigid tube. The groove provides a radially inwardly directed groove surface of varying diameter over an axial length of the groove.

The groove may be disposed axially proximate to and radially inward to the forming surface.

The groove may fully circumscribe the longitudinal die axis.

The groove surface may taper radially inwardly from a radially outer portion disposed proximate to the containment surface to a radially inner portion proximate to the forming surface.

The groove surface may include a pair of axially proximate portions that each taper radially inwardly from axially oppositely disposed radially outer extents towards an axially intermediate shared apex.

A radially outermost extent of the groove surface may be disposed at or radially inward of a radially outermost extent of the forming surface.

The forming surface may axially converge into the groove surface, and the groove surface may axially converge into the containment surface.

The die may further include a retaining recess disposed distally of the fitting recess, and the retaining recess may be configured to radially constrain the tube when received in the retaining recess.

The die may further include an open area disposed distally of the proximal end face and that receives the axial end of the tube to be deformed, where the open area may extend radially outwardly of the flange recess about the longitudinal die axis.

The die may further include an axially adjustable member providing an axially adjustable stop surface that is axially translatable along the longitudinal die axis between the proximal end face and the distal end face, where the stop surface may be selectively adjustable for setting an engagement distance along the longitudinal die axis between the tool and the distal end face.

The axially adjustable stop surface may provide a seat located distally of the proximal end face for being engaged by an axially advancing head supporting the tool.

The proximal end face may include visual indicia disposed about the adjustable stop surface, and the visual indicia may be configured to denote successive axial increments of translation of the adjustable stop surface along the longitudinal die axis.

Another aspect of the invention is a die for receiving a fitting disposed about a rigid tube, the die being for use with a tool to deform an axial end of the rigid tube into contact with an axial end face of the fitting. The die includes a die body having a passage extending through the die body along a longitudinal die axis between a proximal end face and a distal end face disposed opposite the proximal end face.

The die body defines a shelf against which the fitting is engaged when received into the passage. A containment surface extends proximally from the shelf along the longitudinal die axis, wherein the containment surface is of constant diameter over an axial length of the containment surface for supporting a radially outermost extent of the fitting. A groove surface extends proximally of the containment surface along the longitudinal die axis, wherein a radially outermost extent of the groove surface is disposed radially at or radially inward of the containment surface. The groove surface is configured for accepting overflow material of the rigid tube. A forming surface extends proximally of the groove surface along the longitudinal die axis. The forming surface is of constant diameter over an axial length of the forming surface to provide a shutoff-surface for defining a radially outermost perimeter of a flange to be formed from the material of the axial end of the rigid tube. The forming surface is disposed radially at or radially outward of a radially outermost extent of the groove surface.

The groove surface may have a varying diameter over an axial length of the groove surface along the longitudinal die axis.

The containment surface and the forming surface may have substantially equal diameters.

The forming surface may be distally spaced from the proximal end face along the longitudinal die axis.

The die may further include an axially adjustable member providing an axially adjustable stop surface that is axially translatable along the longitudinal die axis between the proximal end face and the distal end face. The stop surface is selectively adjustable for setting an engagement distance along the longitudinal die axis between the tool and the distal end face.

Another aspect of the invention is a method for forming a flange from an axial end of a rigid tube received into a fitting. The method includes the steps of (a) providing the fitting disposed about the rigid tube, (b) introducing the fitting into a fitting recess of a die such that at least an outermost extent of the fitting is circumferentially supported by the fitting recess, (c) translating the rigid tube within the fitting to extend axially from the fitting recess, (d) actuating a tool with an orbital movement and progressively advancing the tool towards the die, and (e) deforming an axial end of the rigid tube in a direction radially outwardly and axially inwardly toward the fitting to form the flange against an axial end face of the fitting. The deforming includes directing material of the axial end of the rigid tube into a flange recess axially proximate the fitting recess such that an inwardly directed annular forming surface of constant axial diameter of the flange recess provides the outermost perimeter of the flange formed in the flange recess. The deforming further includes directing overflow material of the axial end of the rigid tube during formation of the flange into a groove disposed beneath the flange recess and having a diameter less than a diameter of the forming surface.

The deforming may further include directing overflow material into the groove such that the overflow material is axially disposed between the flange recess and the portion of the fitting recess supporting the outermost extent of the fitting, and radially inwardly spaced from the forming surface.

The method may further include selectively adjusting an adjustable surface of the die that is translatable along a longitudinal die axis of the die, to provide for adjustment of a thickness of the flange along the longitudinal die axis.

The foregoing and other features of the invention are hereinafter fully described and particularly pointed out in the claims, the following description and annexed drawings setting forth in detail certain illustrative embodiments of the invention, these embodiments being indicative, however, of but a few of the various ways in which the principles of the invention may be employed.

### BRIEF DESCRIPTION OF THE DRAWINGS

The annexed drawings, which are not necessarily to scale, show various aspects of the disclosure.

FIG. 1 is an orthogonal view of a die according to the present invention, the die for being used to form a flange. The die is shown in partial cross-section to illustrate an adjustable member of the die.

FIG. 2 is an orthogonal view of one half of the die of FIG. 1, shown from the proximal side of the die.

FIG. 3 is an orthogonal view of the half of the die shown in FIG. 2, but shown from the distal side of the die.

FIG. 4 illustrates a flange connection including a flange formed by the die of FIG. 1.

FIG. 5 is an elevated view of the die half shown in FIG. 2, showing the mating surface of the die half for mating with another opposing die half.

FIG. 6 is a cross-sectional elevated view of the die of FIG. 1, with the cross-section taken at the parting surface of the two halves of the die, and showing a tube and fitting received in the die.

FIG. 7 is an enlarged view of the die half shown in FIG. 5.

FIG. 8 is an enlarged view of the die shown in FIG. 6.

FIG. 9 is a partial illustration of the die of FIG. 1 shown with a device for engaging the die to form a flange.

### DETAILED DESCRIPTION

The principles of the present disclosure have general application to a die for forming a flange, and particular application to a die for use in forming an accurately dimensioned metal flange at the axial end of a metal tube for use in a fluid transfer application. For example, a flange connection including a flange formed against a fitting in the die may be utilized in a transportation system for fluids under pressure to provide a leakproof link between axially aligned fluid transfer passages, such as in a hydraulic or pneumatic system. The flanged end may provide a leakproof link for transfer of any suitable fluid, which may include a gas, a liquid, or any combination thereof. The principles of the present disclosure also may have application to a die for forming a flare at the end of a tube, such as a rigid metal tube.

The die is configured to be engaged by a forming tool to deform an axial end of a rigid metal tube into a flange suitable for providing a leakproof link with a sealing element, such as another metal tube or seating surface of a device opening. The die is configured to provide the flange having a generally planar sealing face, a controlled outer diameter, and a controlled thickness along a longitudinal length of the respective metal tube. The die has a die body having a passage extending longitudinally through the die body for securing the rigid metal tube and for securing a fitting received onto the metal tube against which the flange is formed. The passage defines a flange recess providing a shutoff-surface for defining a radially outermost perimeter of the flange formed in the flange recess, and a groove disposed axially adjacent the flange recess that is configured to provide for direction of overflow material of the rigid tube during flange formation. The groove aids in enabling an adequately sized planar sealing face of the flange while reducing or altogether preventing formation of flashing at the generally planar sealing face.

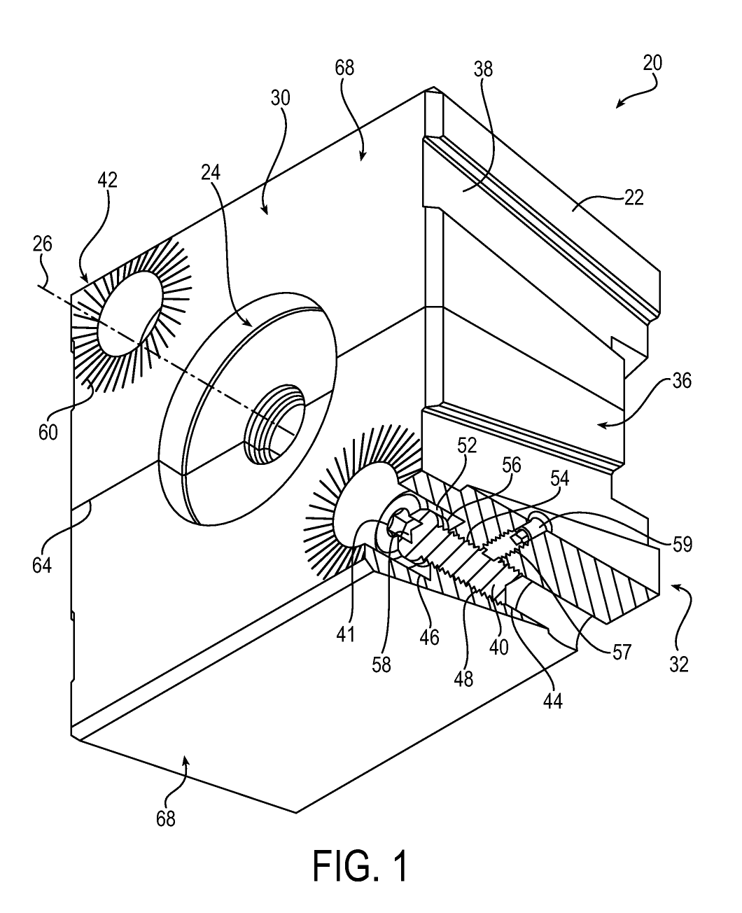

Turning first to FIG. 1, a die 20 is shown for forming a flange of a rigid metal tube. The die 20 has a die body 22 having a passage 24 extending through the die body 22 along a longitudinal die axis 26. The passage 24 is generally cylindrical in shape and extends centrally through the die body 22. The cylindrical shape includes varying diameters due to the passage 24 being stepped along the length of the longitudinal die axis. In other embodiments, the passage may be located elsewhere in the die body 22 or have another suitable shape.

The die body 22 has a proximal end face 30 and a distal end face 32 disposed opposite the proximal end face 30, between which the passage 24 extends in the die body 22. The terms proximal and distal refer to locations relative to a forming tool for which the die 20 is configured to be engaged by to form the flange.

The die body 22 has a substantially quadrilateral shape, such as a substantially square shape, although other shapes may be suitable. The die 20 is formed from a suitable metal such as steel. Other materials may be suitable in other embodiments.

Opposed alignment faces 36 of the die body 22 extend between the proximal end face 30 and the distal end face 32. The alignment faces 36 are configured such that the die 20 may be retained in a device having the forming tool. For example, the alignment faces 36 include slots 38 for receiving corresponding keys of the device, to thereby align the proximal end face 30 and the passage 26 relative to the forming tool. The die also may be aligned relative to a forming tool by other methods, either in the device or external to the device.

To provide for precise alignment relative to the forming tool along the longitudinal die axis 26, the die 20 includes at least one adjustment member 40. The adjustment member 40 has a stop surface 41 that is axially adjustable along the longitudinal die axis 26 between the proximal end face 30 and the distal end face 32. The axially adjustable stop surface 41 provides a seat located distally of the proximal end face 30 for being engaged by an alignment portion of a device supporting the forming tool, such as an alignment portion of an axially advancing head supporting the forming tool. The stop surface 41 is engaged by the alignment portion to thereby set an engagement distance along the longitudinal die axis 26 between the forming tool and the distal end face 32 of the die body 22. The adjustment of the engagement distance provides for corresponding adjustment of dimensions of the flange formed in the die 20, such as of a thickness of the flange formed in the die 20 along the longitudinal die axis 26, or such as of the overall sealing area or diameter of the sealing area of a proximal end face of the flange formed.

As depicted, a pair of oppositely disposed adjustment members 40 are positioned at opposite corners 42 of the die body 22. The adjustment members 40, such as screws, are received into fastener cavities 44 of the die body 22. The depicted fastener cavities 44 include axially proximal counterbored portions 46 adjacent threaded portions 48. The counterbored portions 46 have a larger diameter than the threaded portions 48 for receiving the heads 52 of the adjustment members 40.

The threaded portions 48 include threads 54 for engaging corresponding threads 56 of the adjustment members 40. The threads 54 and 56 are fine adjustment threads, such as allowing for fine adjustment of the engagement distance, for example allowing for adjustments in the range of about 0.0005 inches to about 0.0050 inches. The fine adjustment may allow for reducing or altogether eliminating flashing at the axially proximal end face of the flange, such as flash extending radially outwardly from the longitudinal die axis 26 when the flange is formed. The stop surface 41 of each adjustment member 40 may include an indent 58, such as a hexagonal, linear, or cross-shaped indent, for mating with a corresponding tool for rotating the respective adjustment member 40.

As depicted, additional fasteners, such as set screws 57, extend through setting cavities 59 in the die body 22 for securing respective axial positions of the adjustment members 40 in the fasteners cavities 44. Each setting cavity 59 extends through a side wall of the die body 22, such as through a wall having the alignment face 36, and into a respective fastener cavity 44. The set screws 57 and the setting cavities 59 are correspondingly threaded to allow for advancement along the setting cavities 59 and into securing engagement with the adjustment members 40.

To assist with the fine adjustment of the adjustment member 40, the proximal end face 30 includes visual indicia 60 disposed about the fastener cavities 46 and about the adjustable stop surfaces 41. The depicted visual indicia 60 are visible lines extending outwardly from the perimeter of the fastener cavities 46 at the proximal end face 30. The lines are configured to denote rotational increments of the adjustment members 40 corresponding to successive axial increments of translation of the adjustable stop surfaces 41 along the longitudinal die axis 26. For example, the lines may be circumferentially spaced from one another in increments of about 0.0005 inches to about 0.0020 inches. The visual indicia may be an imprint into the proximal face 30, protrusions extending from the proximal face 30, or be printed on the proximal face 30.

Also at the proximal end face 30, and extending fully about the die body 22, is a parting line 64. The parting line 64 is formed where two equal die portions 68 of the die 20 mate to form the complete die 20. The depicted die portions 68 are die halves 68 of generally equal proportions. The passage 24 is separated into two equal passage halves at the parting line 64.

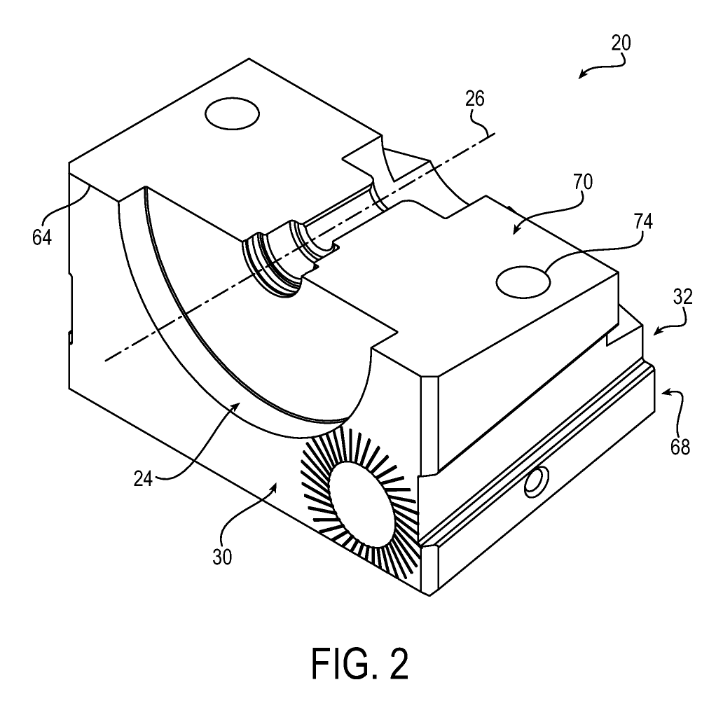

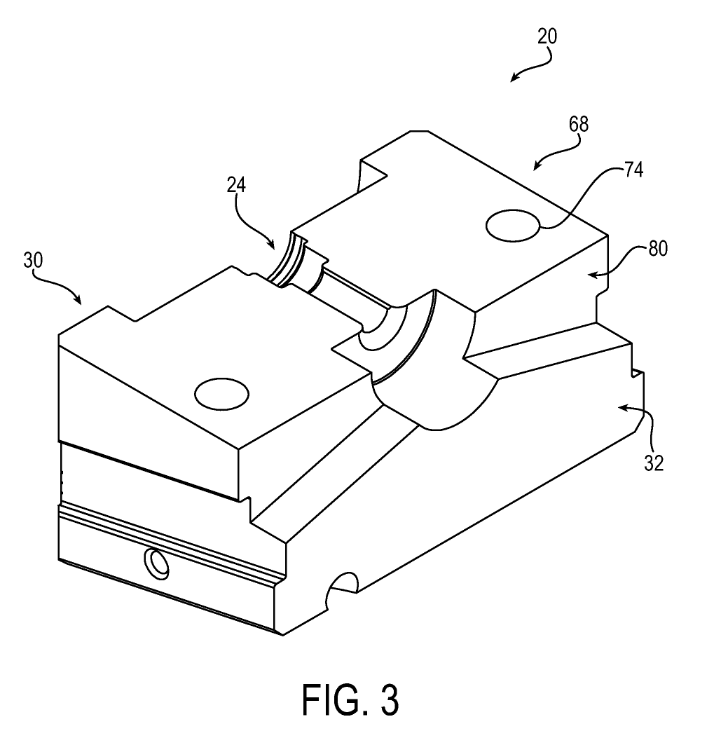

As illustrated in FIGS. 2 and 3, the die halves 68 each have a mating face 70 at least partially defining the parting line 64 of the complete die 20. One or more connection cavities 74, and as depicted two oppositely disposed connection cavities 74, extend into the die body 22 of each die half 68 at the respective mating faces 70. The connection cavities 74 are configured, such as being shaped, to receive connecting pins (not shown) for being received by oppositely disposed connection cavities 74 of each of the die halves 68 to align the die halves 68 and their corresponding passage halves relative to one another.

As depicted in FIG. 3, the distal end face 32 has a channel 80 extending through the distal end face 32 to allow use of the die 20 with a bent tube that is to have a flange formed at an axial end of the tube. The channel 80 provides clearance for a portion of the tube that is bent out of axial alignment from the tube portion received into the passage 24, where at least part of the bent portion of the tube may be retained in the channel 80 during forming of a flange at the proximal end of the tube proximate the fitting.

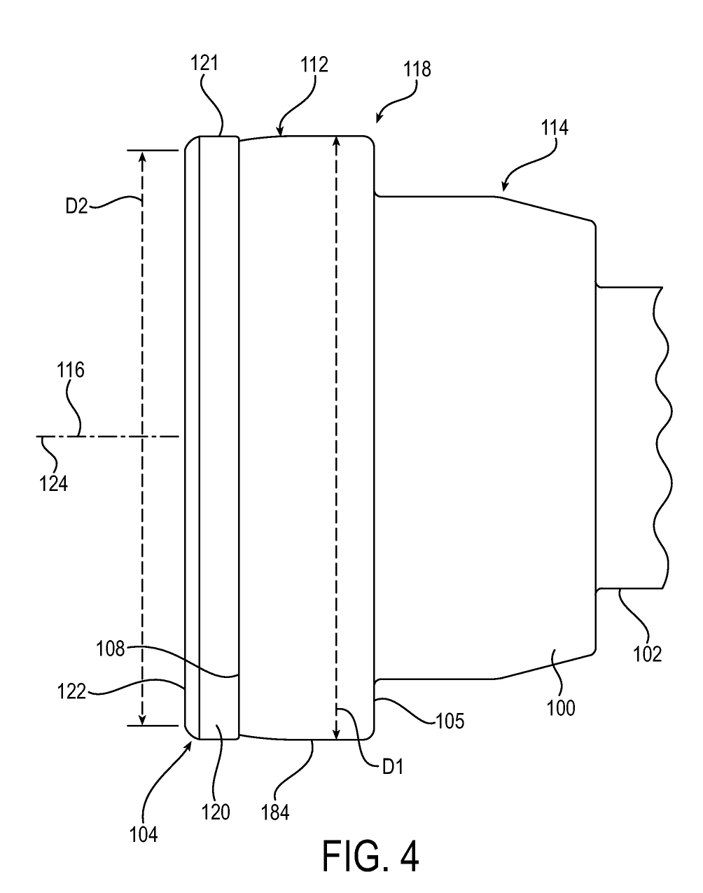

The fitting is illustrated at 100 in FIG. 4, with the tube, illustrated at 102, together forming aspects of a flange connection 118. The fitting 100 may be any suitable fitting, for use in making a leakproof fluid transport connection between the finalized flange connection and the external sealing element. Such fittings 100 generally are annular in shape and are disposed about a central fitting axis, such as the depicted longitudinal fitting axis 124.

A distal land 105 is provided at a distally-located side of the fitting 100 for being engaged by a connecting surface separate from or integral with the external sealing element. A proximal land 108 is disposed opposite the distal land 105, and as depicted, is typically configured for having the flange 120 of the tube 102 formed thereagainst for completing the flange connection 118. The depicted fitting 100 includes a proximal portion 112 having the proximal land 108 at a proximal end of the proximal portion 112 and a distal portion 114 having the distal land 105 at a distal end of the distal portion 114. The proximal portion 112 has a greater outermost diameter D1 than an outermost diameter of the distal portion 114.

The tube 102 is a rigid metal tube about which the fitting 100 is received. The tube 102 extends along a longitudinal tube axis 116, which as depicted, is co-linear with the longitudinal fitting axis 124. The tube 102 is rigid in that it maintains its shape disposed along the central longitudinal tube axis 116 absent external forces acting on the tube 102. The die 20 is particularly optimized for use with thin-walled tubes, such as having a wall thickness between about 0.020 inches to about 0.100 inches. The die 20 also may be suitable for use with tubes 102 having a greater wall thickness. The tube 102 may be made of any material suitable for having the flange 120 formed at the axial end 104. The tube 102 includes the flange 120 formed at its proximal axial end 104, such as against the proximal land 108. The flange 120 is formed using the die 20, as a result of the configuration of the passage 24, to be further explained in detail.

Generally, a forming tool engaging the proximal end 104 of the tube 102 causes deformation of the tube 102 such that the material of the proximal end 104 is formed into the flange 120. The material of the tube 102 forming the flange 120 may extend slightly over and axially distal of the proximal land 104 of the fitting 100. The flange 120 includes a radially outermost surface 121 disposed radially outward of an annular sealing face 122, also herein referred to as a sealing surface 122.

The sealing face 122 is generally planar and disposed in a plane generally orthogonal to a central longitudinal axis 124 of the fitting 100. The sealing surface 122 has an area that is sufficient for providing a leakproof seal with the external sealing element (not shown). An outer diameter D2 of the sealing surface 122, and also a thickness of the flange 122 extending axially between the sealing surface 122 and the proximal land 108, are controlled via use of the die 20, including via selective adjustment of the adjustment members 40 in concert with the unique aspects of the passage 24 defined in the die body 22.

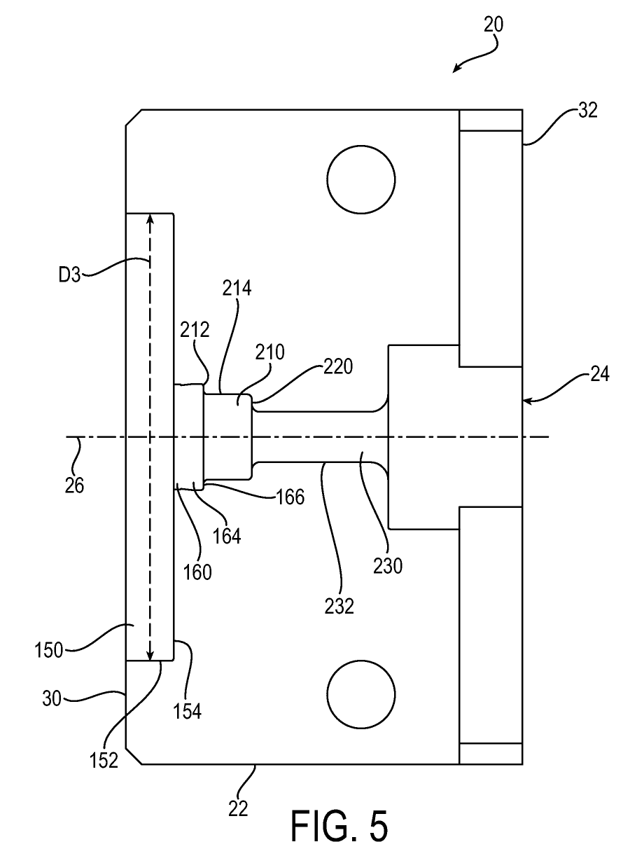

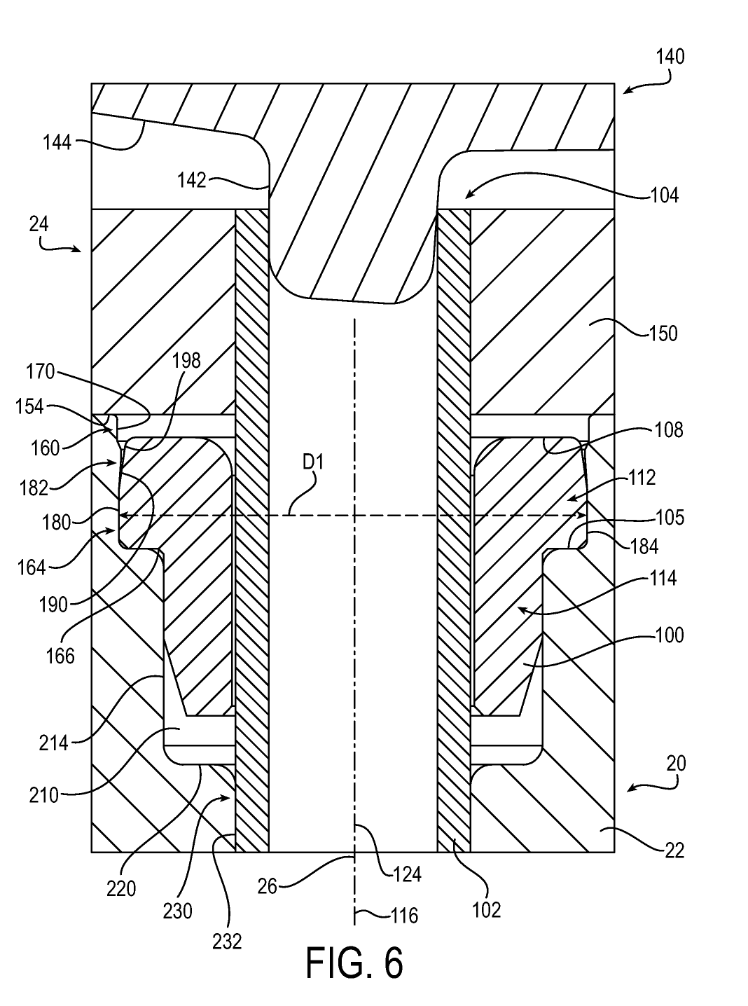

Turning now in particular to FIGS. 5 and 6, the depicted passage 24 of the die body 22 is configured to provide for formation of the flange 120. FIG. 5 illustrates the passage 24 without the tube 102 and the fitting 100 disposed in the passage 24, while FIG. 6 illustrates the same passage 24 of the die 20 with the tube 102 and the fitting 100 received in the passage 24 prior to forming of the flange 120 (FIG. 4) at the proximal end 104 of the tube 102. In FIG. 6, the fitting 100 and the tube 102 are secured in the passage 24 such that the longitudinal tube axis 116 and the longitudinal flange axis 124 are aligned with, such as being co-linear with, the longitudinal die axis 26.

The passage 24 is configured to retain the fitting 100 and the tube 102 while a forming tool 140, such as an orbitally moving pin 140, is axially advanced along the longitudinal die axis 26 into engagement with the proximal axial end 104 of the tube 102 to form the flange 120. The pin 140 includes a centrally-located protrusion 142 for being received into the tube 102, and a radially-outer portion 144 for engaging the proximal end face 146 of the proximal end 104.

At the most proximal end of the passage 24, an open area 150 is defined by the die body 22 for receiving the pin 140. The open area 150 circumscribes the longitudinal die axis 26 and is located distally of the proximal end face 30. The open area 150 includes a radially inwardly directed surface 152 that extends axially between the proximal end face 30 and a proximal shelf 154 of the open area 150. The surface 152 is shown as being of a constant diameter D3 over the full axial length of the surface 152, although the diameter may vary in other embodiments.

The axial length of the surface 152 along the longitudinal die axis 26 is equal to the corresponding length of a particular tube 102 having a particular diameter and wall thickness that is necessary to form a particular flange 120 at the proximal end of the tube 102. For example, the proximal end 104 of the tube 102 may be received into the open area 150 and into abutment with a tube locator (not shown) that is selectively engaged at the proximal end face 30 of the die 20, prior to being retracted to allow for advancement of the pin 140 into engagement with the proximal end 104 of the tube 102.

Furthermore, an axial distance between the proximal shelf 154 and the radially-outer portion 144 is controlled via selective adjustment of the adjustment members 40 to control the dimensions of the flange 120. For example, fine adjustment of the adjustment members 40 may allow for a distance between the proximal shelf 154 and the maximum distally-advanced position of the radially-outer portion 144 in the range of about 0.000 inches to about 0.005 inches.

The die body 22 further defines both a flange recess 160 and a fitting recess 164 axially disposed between the proximal shelf 154 and an intermediate shelf 166. The intermediate shelf 166 is distally spaced along the longitudinal die axis 26 from the proximal shelf 154. The distal land 105 of the fitting 100 is engaged against the intermediate shelf 166 when the fitting 100 is received into the passage 24, thereby providing an axially located seating surface to axially align the fitting 100 relative to the proximal end face 30 of the die 20. Both the proximal shelf 154 and the intermediate shelf 166 are depicted as being generally flat surfaces disposed in respective planes that are parallel to one another and generally orthogonal to the longitudinal die axis 26.

The flange recess 160 is disposed axially distal of and extends from the proximal shelf 154 to the fitting recess 164. The flange recess 160 is configured, such as being shaped, to have the flange 120 formed in the flange recess 160 from the material of the axial end 104 of the tube 102 when the tube 102 is engaged by the forming tool or pin 140. A radially inwardly directed forming surface 170 of the flange recess 160 is configured to be engaged by the material that is deformed into the flange recess 160 to provide a shut-off surface for defining the radially outermost perimeter 121 of the flange 120 to be formed in the flange recess 160. The forming surface 170 extends fully between the proximal shelf 154 and the fitting recess 164 and is distally spaced from the proximal end face 30 along the longitudinal die axis 26 by the open area 150. The forming surface 170 is of constant diameter over an axial length of the forming surface 170 along the longitudinal die axis 26, thereby enabling a uniform cylindrical outer surface 121 (FIG. 4) of the flange 120 to be formed.

The fitting recess 164 is disposed axially proximate to the flange recess 160 and forming surface 170 for receiving the fitting 100. The fitting recess 164 extends between the forming surface 170 and the axially facing intermediate shelf 166. In particular, the fitting recess 164 extends from the forming surface 170, such that the fitting recess 164 and the forming surface 170 share an annular linear ring of the passage 24 therebetween. The fitting recess 164 includes a distally-located containment surface 180 and a proximally-located groove 182.

The containment surface 180 is a radially inwardly directed surface of the fitting recess 164 that is configured for retaining and supporting the proximal portion 112 of the fitting 100. The containment surface 180 engages the radially outermost extent 184 of the fitting 100, which as depicted is at the proximal portion 112. The containment surface 180 is a surface of constant diameter over an axial length of the containment surface 180 along the longitudinal die axis 60. The containment surface 180 is disposed axially adjacent the intermediate shelf 166, such as extending proximally from the intermediate shelf 166 to the groove 182, as depicted. An annular linear ring of the passage 24 is shared between the containment surface 180 and the groove 182.

The groove 182 is configured to aid in formation of the flange 120. Particularly, the groove 182 is shaped and located to provide for direction of overflow material of the flange 120 into the groove 182. For example, the groove 182 may allow for the formation of the sufficient outer diameter D2 of the sealing face 122 of the flange 120 (FIG. 4), while also reducing or altogether preventing flashing at an outer perimeter of the sealing face 122. The material directed into the groove 182 will be disposed between a radially inwardly directed groove surface 186 of the groove 182 and a radially outer surface 121 of the proximal portion 112 of the fitting 100. To provide for such direction, the groove 182 generally is disposed axially proximate to and radially inward to the forming surface 170. Accordingly, as depicted, the material of the tube 102 directed into the groove will be located axially proximate to and radially inward to the radially outermost surface 121 of the flange 120. As used herein, the term proximate denotes a close proximity to, but not necessarily a convergence with, another aspect.

The location of the groove 182 is axially distal of the forming surface 170 and axially proximal of the containment surface 180. Particularly, the depicted groove 182 extends from each of the forming surface 170 and the containment surface 180 and thus shares an annular linear ring with each of the forming surface 170 and the containment surface 180. For example, the forming surface 170 axially converges into the groove surface 186, and the groove surface 186 axially converges into the containment surface 180. The groove surface 186 also fully circumscribes the longitudinal die axis 26.

At a proximal end of the groove surface 186, a radially outermost extent of the groove surface 186 is disposed radially at or radially inward of the forming surface 170. Likewise, at a distal end of the groove surface 186, a radially outermost extent of the groove surface 186 is disposed radially at or radially inward of the of the containment surface 180.

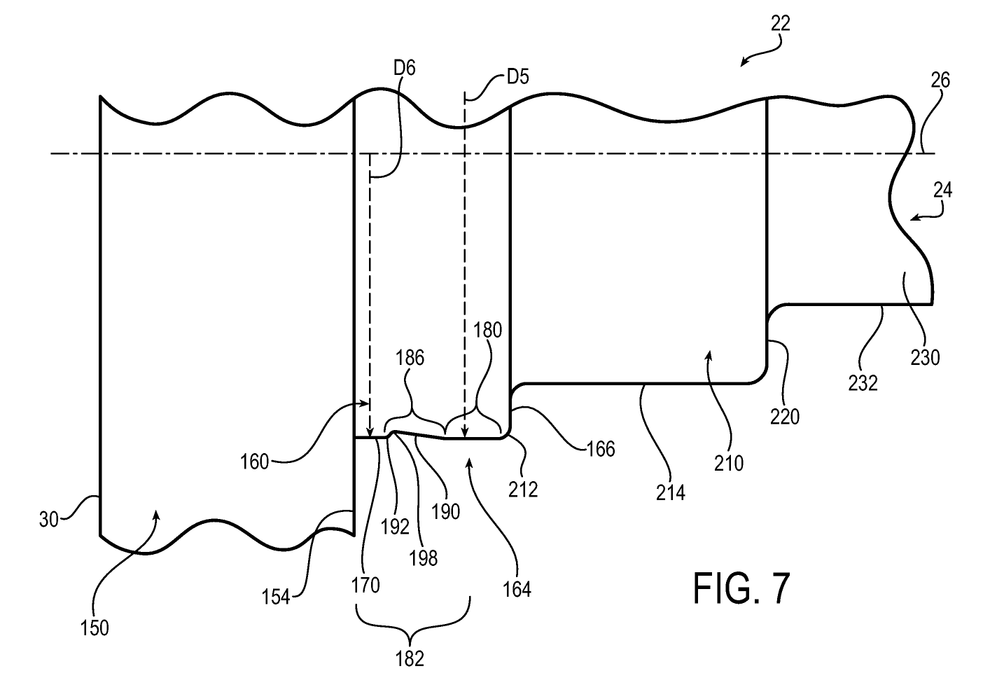

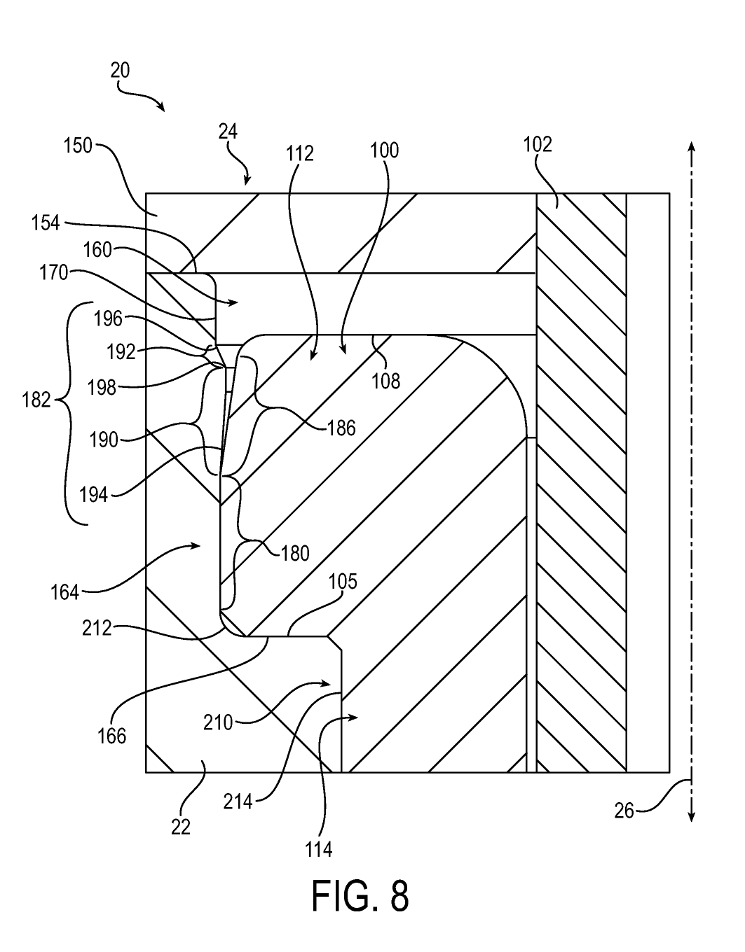

Looking now in particular to FIGS. 7 and 8, showing enlarged views of FIGS. 5 and 6, respectively, the groove 182 has a varying diameter over its axial length, and thus the groove surface 186 is a surface of varying diameter over an axial length of the groove surface 186 along the longitudinal axis 26. The groove surface 186 includes at least one radially inwardly directed tapered portion axially disposed between the forming surface 170 and the containment surface 180. The at least one tapered portion tapers radially inwardly along the longitudinal axis 26 to a radially inward most aspect that is disposed radially inward of each of the forming surface 170 and the containment surface 180.

For example, the depicted groove surface 186 includes a pair of axially proximate portions 190 and 192 that each taper radially inwardly in opposite axial directions and converge at a shared apex 198. The primary axially proximate portion 190 is disposed distal to the secondary axially proximate portion 192. Furthermore, as depicted, the primary axially proximate portion 190 has a lesser length over the longitudinal die axis 26 than the secondary proximate portion 192.

The primary axially proximate portion 190 tapers radially inwardly along the longitudinal axis 26 from a radially outer extent 194 to the shared apex 198. The radially outer extent 194 is disposed proximate, such as extending from, the containment surface 180. The secondary axially proximate portion 192 tapers in an opposite axial direction, radially inwardly along the longitudinal axis 26 from a radially outer extent 196 to the shared apex 198. The radially outer extent 196 is disposed proximate, such as extending from, the forming surface 170. Further, a diameter D5 of the containment surface 180 and a diameter D6 of the forming surface 170 are substantially equal, though may be otherwise dimensioned in other embodiments.

In other embodiments, one of the proximate tapered portions 190 or 192 may be omitted. Additionally or alternatively, one or more additional tapered portions or portions of constant diameter may be included in the groove 182, such as between the tapered portions 190 and 192.

Referring still to FIGS. 7 and 8, but also shown in FIGS. 5 and 6, a lower recess 210 is located distally to each of the groove 182 and the containment surface 180 of the fitting recess 164, such as extending from the intermediate shelf 166. An edge, such as a fillet 212, is axially disposed between the intermediate shelf 166 and a radially inwardly directed surface 214 of the lower recess 210. In other embodiments, the edge 212 may be of another suitable shape, such as a chamfer.

The lower recess 210 is configured to retain and secure the distal portion 114 of the fitting 100. The surface 214 has a constant diameter over the longitudinal die axis 26 for engaging the outermost diameter of the distal portion 114. The surface 214 extends between the intermediate shelf 166 and a distal shelf 220. The distal shelf 220 is generally flat and is disposed in a plane generally orthogonally disposed to the longitudinal die axis 126.

In some embodiments, the lower recess 210 may be omitted, such as where a respective fitting 100 lacks a corresponding distal portion 114. Additional or alternative lower recesses of the same or different proportions may be included, such as where the fitting 100 includes other corresponding portions.

Distal to the lower recess 210 is a retaining recess 230 for securing and supporting a length of the tube 102 along the longitudinal die axis 26. Particularly, a portion of the tube 102 disposed distal to the fitting 100 is radially constrained in the retaining recess 230 when the fitting 100 and tube 102 are jointly retained in the passage 24 of the die body 22. The retaining recess 230 includes a radially inwardly directed surface 232 of constant diameter along the longitudinal die axis 26 that extends distally of the distal shelf 220, between the distal shelf 220 and the distal end face 32.

Any one or more of the stepped portions of the passage 24 defining the open area 150, the flange recess 160, the fitting recess 164, the lower recess 210, and the retaining recess 230 may have a non-cylindrical shape in other embodiments. Additional recesses, radially inwardly directed surfaces, or axially-facing surfaces may be included in other embodiments at any suitable location of the passage 24 along the longitudinal die axis 26, such as between any of the recesses, surfaces, or faces of the passage 24. Further, any one or more of the surfaces described as having constant diameters over an axial length of the surfaces may have an interrupt in said constant diameters in other embodiments.

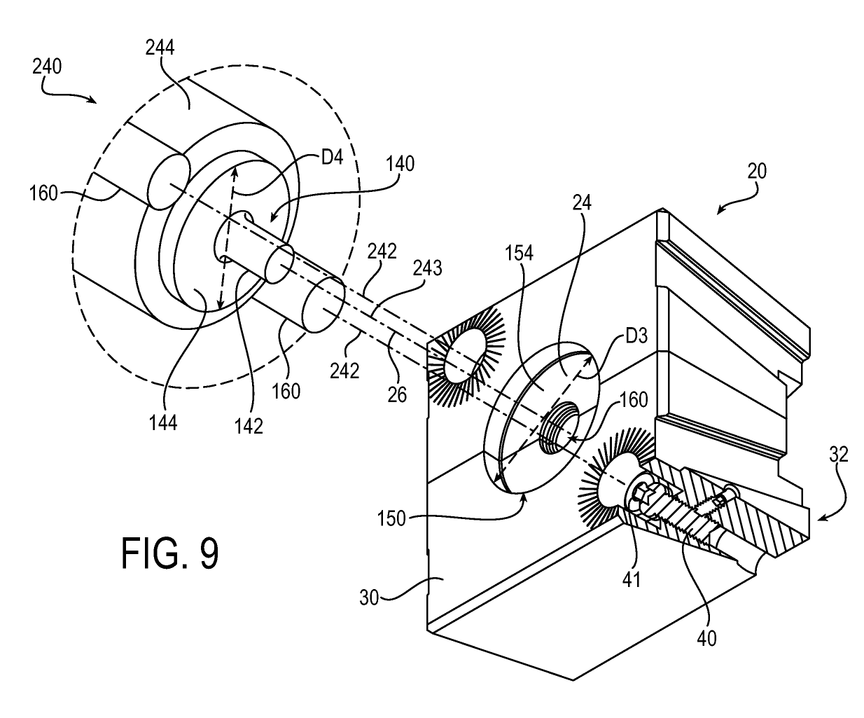

Looking next to FIG. 9, a partial depiction of a device 240 is illustrated for use with the die 20. The device 240 is shown including the forming tool or pin 140, with a schematic illustration of engagement of the device 240 with the die 20 illustrated by dashed engagement lines 242 and 243. The device 240 includes a head 244 supporting the forming tool or pin 140 for orbital movement of the pin 140.

As schematically depicted, when the head 244 axially advances towards the proximal end face 30 of the die 20, the protrusion 142 advances along the respective dashed engagement line 243, which is co-linear with the longitudinal die axis 26. The protrusion 142 thus advances along the longitudinal die axis 26 towards the flange recess 160.

Also when the head 244 axially advances towards the die 20, the radially-outer portion 144 advances toward the open area 150 and the proximal shelf 154. The open area 150 has a diameter D3 that is greater than a diameter D4 of the radially-outer portion 144. The corresponding diameters D3 and D4 allow for receipt of the radially-outer portion 144 into the open area 150, such as at the end of formation of the flange 120. As mentioned above, at such stage, the distance between the proximal shelf 154 and the maximum distally-advanced position of the radially-outer portion 144 may be in the range of about 0.000 inches to about 0.005 inches.

Projecting from the head 244 are a pair of alignment portions, such as projections 160. The projections 160 are disposed opposite one another across a surface of the head 244 with the forming tool 140 disposed therebetween. As schematically depicted, the projections 160 are each caused to advance along the respective engagement lines 242 into engagement with respective stop surfaces 41 of the adjustment members 40. The head 244 is axially stopped along the longitudinal die axis 26/engagement line 243 via hard engagement of the projections 160 with the adjustment members 40.

Still looking to FIG. 9, but referring in part to the flange 120 illustrated in FIG. 4, the present invention further includes a method for forming a flange 120 from an axial end 104 of the rigid tube 102 received into the fitting 100. The method includes the steps of (a) providing the fitting 100 disposed about the rigid tube 102, and (b) introducing the fitting 100 into a fitting recess 164 of the die 20 such that at least the outermost extent 184 of the fitting 100 is circumferentially supported by the fitting recess 164. The method further includes the steps of (c) translating the rigid tube 102 within the fitting 100 to extend axially from the fitting recess 164, and (d) actuating a tool 140 with an orbital movement and progressively advancing the tool 140 towards the die 20. The method further includes (e) deforming an axial end 104 of the rigid tube 102 in a direction radially outwardly and axially inwardly (i.e., distally) toward the fitting 100 to form the flange 120 against an axial end face at the proximal land 108 of the fitting 100.

The method includes the step of selectively adjusting the adjustable surface 41 of the die 20 that is translatable along a longitudinal die axis 26 of the die 20, to provide for adjustment of a thickness of the flange 20 along the longitudinal die axis 26. The method also includes the step of bringing the head 244 supporting the tool 140 into a hard stop with the adjustable surface 41.

The deforming includes directing material of the axial end 104 of the rigid tube 102 into the flange recess 160 axially proximate the fitting recess 164, such that an inwardly directed annular forming surface 170 of constant axial diameter of the flange recess 160 provides the outermost perimeter 121 of the flange 120 formed in the flange recess 160. Also, the deforming further includes directing overflow material of the axial end 104 of the rigid tube 102 during formation of the flange 120 into a groove 182 disposed beneath the flange recess 160 and having a diameter less than the diameter D6 of the forming surface 170. The deforming further includes directing overflow material into the groove 182 such that the overflow material is axially disposed between the flange recess 160 and the portion of the fitting recess 164 supporting the outermost extent 184 of the fitting 100, and radially inwardly spaced from the forming surface 170.

The present invention provides a die 20 and a method for forming a flange 120 at an axial end 104 of a rigid metal tube 102. The die 20 is configured to be engaged by a forming tool 140 to deform the axial end 104 of the rigid metal tube 102 into the flange 120 suitable for providing a leakproof link with an external sealing element. A flange recess 160 in the die 20 provides a shutoff-surface 170 for defining a radially outermost perimeter (at the radially outer most extent 121) of the flange 120 formed in the flange recess 160, and a groove 182, disposed axially adjacent the flange recess 160, that is configured to provide for direction of overflow material of the rigid tube 102 during flange formation. The groove 182 aids in enabling an adequately sized planar sealing face 122 of the flange 120 while reducing or altogether preventing formation of flashing at the sealing face 122.

Via inclusion of the groove 182 and the flange recess 160 in the die body 22, the resultant flange 120 may be provided having generally consistent dimensions from part to part and also having dimensions conforming to respective industry standards. For example, the forming surface 170 being provided as a shut-off surface enables the formation of a uniform outer perimeter 121 (FIG. 4) of the flange 120. An adequate thickness of the flange 120 along the longitudinal die axis 26 is provided at least in part due to the dimensions of the flange recess 160 in concert with the location of the groove 182, which is positioned generally radially inward of and distally below the flange recess 160. By providing the groove 182 as a location for direction of overflow material from the axial end 104 of the tube 102, the sealing face 122 (FIG. 4) may be better provided with a target diameter and area. Coincidingly, formation of flashing at the outer perimeter of the sealing face 122 may be reduced or altogether prevented, thereby eliminating the need for a secondary manufacturing step to de-flash the flange 120.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A die for receiving a fitting disposed about a rigid tube, the die for use with a tool to deform an axial end of the rigid tube into contact with an axial end face of the fitting, the die comprising:
a die body having a passage extending through the die body along a longitudinal die axis between a proximal end face and a distal end face disposed opposite the proximal end face,
the die body defining:
a flange recess having a radially inwardly directed forming surface configured to be engaged by material of the axial end of the rigid tube that is deformed into the flange recess, the forming surface providing a shutoff-surface for defining a radially outermost perimeter of a flange to be formed from the material of the axial end of the rigid tube, and
a fitting recess disposed axially proximate to the flange recess for receiving the fitting, the fitting recess extending between the forming surface and an axially facing shelf for receiving the fitting thereon, the fitting recess including a proximally-located groove and a distally-located containment surface,
wherein the containment surface is disposed axially adjacent the axially facing shelf and is a radially inwardly directed surface of constant diameter over an axial length of the containment surface for supporting a radially outermost extent of the fitting, and
wherein the groove is axially disposed between the forming surface and the containment surface to provide for direction of overflow material of the rigid tube, the groove providing a radially inwardly directed groove surface of varying diameter over an axial length of the groove.

2. The die of claim 1, wherein the groove is disposed axially proximate to and radially inward to the forming surface.

3. The die of claim 1, wherein the groove fully circumscribes the longitudinal die axis.

4. The die of claim 1, wherein the groove surface tapers radially inwardly from a radially outer portion disposed proximate to the containment surface to a radially inner portion proximate to the forming surface.

5. The die of claim 1, wherein the groove surface includes a pair of axially proximate portions that each taper radially inwardly from axially oppositely disposed radially outer extents towards an axially intermediate shared apex.

6. The die of claim 1, wherein a radially outermost extent of the groove surface is disposed at or radially inward of a radially outermost extent of the forming surface.

7. The die of claim 1, wherein the forming surface axially converges into the groove surface, and wherein the groove surface axially converges into the containment surface.

8. The die of claim 1, wherein the die further includes a retaining recess disposed distally of the fitting recess, and wherein the retaining recess is configured to radially constrain the tube when received in the retaining recess.

9. The die of claim 1, wherein the die further includes an open area disposed distally of the proximal end face and that receives the axial end of the tube to be deformed, wherein the open area extends radially outwardly of the flange recess about the longitudinal die axis.

10. The die of claim 1, further including an axially adjustable member providing an axially adjustable stop surface that is axially translatable along the longitudinal die axis between the proximal end face and the distal end face, wherein the stop surface is selectively adjustable for setting an engagement distance along the longitudinal die axis between the tool and the distal end face.

11. The die of claim 10, wherein the axially adjustable stop surface provides a seat located distally of the proximal end face for being engaged by an axially advancing head supporting the tool.

12. The die of claim 10, wherein the proximal end face includes visual indicia disposed about the adjustable stop surface, and wherein the visual indicia are configured to denote successive axial increments of translation of the adjustable stop surface along the longitudinal die axis.

13. A die for receiving a fitting disposed about a rigid tube, the die for use with a tool to deform an axial end of the rigid tube into contact with an axial end face of the fitting, the die comprising:
a die body having a passage extending through the die body along a longitudinal die axis between a proximal end face and a distal end face disposed opposite the proximal end face,
the die body defining:
a shelf against which the fitting is engaged when received into the passage,
a containment surface extending proximally from the shelf along the longitudinal die axis, wherein the containment surface is of constant diameter over an axial length of the containment surface for supporting a radially outermost extent of the fitting,
a groove surface extending proximally of the containment surface along the longitudinal die axis, wherein a radially outermost extent of the groove surface is disposed radially at or radially inward of the containment surface, and wherein the groove surface is configured for accepting overflow material of the rigid tube, and
a forming surface extending proximally of the groove surface along the longitudinal die axis, wherein the forming surface is of constant diameter over an axial length of the forming surface to provide a shutoff-surface for defining a radially outermost perimeter of a flange to be formed from the material of the axial end of the rigid tube, and wherein the forming surface is disposed radially at or radially outward of a radially outermost extent of the groove surface.

14. The die of claim 13, wherein the groove surface has a varying diameter over an axial length of the groove surface along the longitudinal die axis.

15. The die of claim 13, wherein the containment surface and the forming surface have substantially equal diameters.

16. The die of claim 13, wherein the forming surface is distally spaced from the proximal end face along the longitudinal die axis.

17. The die of claim 13, further including an axially adjustable member providing an axially adjustable stop surface that is axially translatable along the longitudinal die axis between the proximal end face and the distal end face, wherein the stop surface is selectively adjustable for setting an engagement distance along the longitudinal die axis between the tool and the distal end face.

18. A method for forming a flange from an axial end of a rigid tube received into a fitting, the method including the steps of:
providing the fitting disposed about the rigid tube;
introducing the fitting into a fitting recess of a die such that at least an outermost extent of the fitting is circumferentially supported by the fitting recess;
translating the rigid tube within the fitting to extend axially from the fitting recess;
actuating a tool with an orbital movement and progressively advancing the tool towards the die;
deforming an axial end of the rigid tube in a direction radially outwardly and axially inwardly toward the fitting to form the flange against an axial end face of the fitting,
the deforming including directing material of the axial end of the rigid tube into a flange recess axially proximate the fitting recess such that an inwardly directed annular forming surface of constant axial diameter of the flange recess provides the outermost perimeter of the flange formed in the flange recess, and
the deforming further including directing overflow material of the axial end of the rigid tube during formation of the flange into a groove disposed beneath the flange recess and having a diameter less than a diameter of the forming surface.

19. The method of claim 18, wherein the deforming further includes directing overflow material into the groove such that the overflow material is axially disposed between the flange recess and the portion of the fitting recess supporting the outermost extent of the fitting, and radially inwardly spaced from the forming surface.

20. The method of claim 18, selectively adjusting an adjustable surface of the die that is translatable along a longitudinal die axis of the die, to provide for adjustment of a thickness of the flange along the longitudinal die axis.
